(19) United States
(12) Patent Application Publication
(10) Pub. No.: US 2024/0028960 A1
(43) Pub. Date: Jan. 25, 2024

(54) METHOD FOR EVALUATING THE PERFORMANCE OF A PREDICTION ALGORITHM, AND ASSOCIATED DEVICES

(71) Applicant: THALES, Courbevoie (FR)

(72) Inventor: Pierre-Yves LAGRAVE, Palaiseau (FR)

(21) Appl. No.: 18/254,749

(22) PCT Filed: Nov. 30, 2021
(86) PCT No.: PCT/EP2021/083472

§ 371 Date: May 26, 2023

(30) Foreign Application Priority Data
Nov. 30, 2020 (FR) FR2012387

(51) Int. Cl. G06N 20/00

(52) U.S. Cl. CPC G06N 20/00

(57) ABSTRACT

The invention relates to a method for evaluating the performance of a prediction algorithm predicting the outputs for given inputs, the algorithm having been trained using a machine learning technique, the method including the steps of: obtaining data sets, each datum of a set corresponding to the outputs that the algorithm should give in the presence of the inputs of the set, receiving the probability that a set is observed, collecting the outputs predicted by the algorithm for each input of the data of the sets, determining the distribution of the prediction precision of the predicted output, aggregating the distributions determined by using an aggregation function using the probabilities received, and applying at least one risk metric to the aggregated distribution of prediction precision, for obtaining at least one indicator of the algorithm performance.

The present invention relates to a method for evaluating the performance of a predicting algorithm. The invention further relates to a computer product program and to an associated readable storage medium.

The present invention is in the field of developing prediction algorithms which have been trained using a machine learning technique.

Machine learning is referred to by many different terms such as the term “machine learning”, the term “automatic learning”, the term “artificial learning” or the term “statistical learning”. Machine learning involves using data to train a prediction algorithm.

However, if the prediction algorithm thus trained is efficient for the data set used for the training thereof, this does not prove that the prediction algorithm is suitable for to the use case wherein the algorithm is intended to be used.

Different approaches exist for evaluating algorithmic performance, such as conducting robustness analysis experiments or using formal methods for certification in a predefined data range.

However, such approaches give only partial answers to the measurement problem and do not take into account all use cases, making the approaches imprecise.

Hence, there is a need for a more precise method for evaluating the performance of a prediction algorithm.

To this end, the description describes a method for evaluating the performance of a prediction algorithm for a predefined use case, the prediction algorithm predicting for given inputs the value of one or a plurality of outputs, the prediction algorithm having been trained using a machine learning technique and a learning data set, the method including a step of obtaining data sets, each datum in a data set corresponding to the output values that the prediction algorithm should give in the presence of the input values of the data set, a step of receiving the probability for each data set that a data set will be observed when using the prediction algorithm, a step of collecting the outputs predicted by the prediction algorithm for each input value of the data sets, a step of determining the distribution of the predicted output prediction precision for each data set, so as to obtain determined distributions, a step of aggregating the determined distributions by means of an aggregation function using the received probabilities for obtaining an aggregated distribution of prediction precision, and a step of applying at least one risk metric to the aggregated distribution of prediction precision, so as to obtain at least one indicator of the performance of the prediction algorithm.

According to particular embodiments, the evaluation method has one or a plurality of the following features, taken individually or according to all technically possible combinations:
a risk metric is a quantile metric and an indicator of the performance of the prediction algorithm is the value of a quantile of predetermined level.
a risk metric is a conditional expectation and an indicator of the performance of the prediction algorithm is a value of the conditional expectation.
the prediction precision is calculated using an evaluation metric, the evaluation metric being an average of the absolute prediction error, a quantile metric, or an empirical moment of the distribution of the prediction precision.
the prediction precision is calculated using a reference prediction algorithm.
the method includes the drawing up of a report giving all the information used for obtaining the performance indicator.
the obtaining step is implemented by generating each data set from a reference data set according to a given probability law.
the obtaining step is implemented, for each data set, by generating, by means of a generative model, of initial data and by selecting, according to a given probability law, the initial data for forming the data set.
the obtaining step includes the modification of the data sets by introducing imperfections of the environment of the system the prediction algorithm models.
the obtaining step includes the modification of the data sets by introducing adverse perturbations aimed at manipulating the outputs of the prediction algorithm.

The present description further describes a computer program product comprising a readable storage medium, on which is stored a computer program comprising program instructions, the computer program being loadable on a data processing unit and implementing an evaluation method as described hereinabove when the computer program is implemented on the data processing unit.

The description further describes a readable storage medium including program instructions forming a computer program, wherein the computer program can be loaded on a data processing unit and implements an evaluation method as described hereinabove when the computer program is implemented on the data processing unit.

The invention will be better understood and other advantages thereof will appear more clearly in the light of the following description, given only as an example and made with reference to the enclosed drawings, wherein:

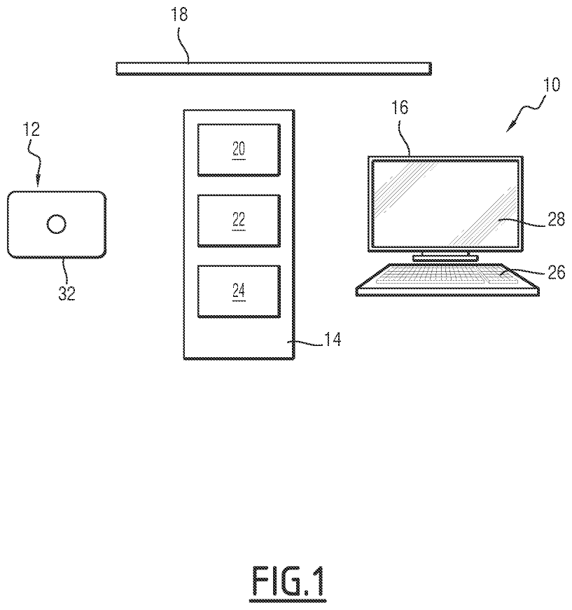

FIG. 1 is a schematic representation of a system and of a computer program product, and

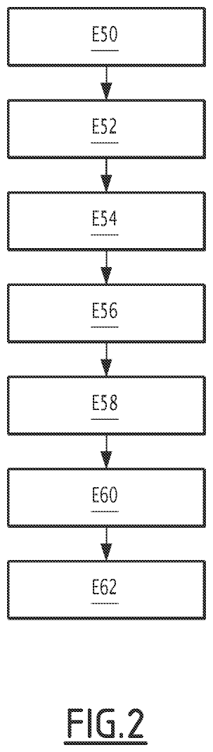

FIG. 2 is a flowchart of an example of implementation of a method for evaluating a prediction algorithm.

A system 10 and a computer program product 12 are shown in FIG. 1.

The interaction between the system 10 and the computer program product 12 makes it possible to implement a method for evaluating a prediction algorithm. Thereby, the evaluation method is a method implemented by a computer.

The system 10 is a desktop computer. In a variant, the system 10 is a computer mounted on a rack, a laptop, a tablet, a personal digital assistant (PDA) or a smartphone.

In specific embodiments, the computer is suitable for operating in real time and/or is in an on-board system, in particular in a vehicle such as an aircraft.

In the case shown in FIG. 1, the system 10 comprises a calculation unit 14, a user interface 16 and a communication device 18.

More generally, the computer 14 is an electronic computer suitable for handling and/or transforming data represented as electronic or physical quantities in registers of the system 10 and/or memories in other similar data corresponding to physical data in the register memories or other types of displays, transmission devices or storage devices.

As specific examples, the computing unit 14 comprises a single-core or multi-core processor (such as a central processing unit (CPU), a graphics processing unit (GPU), a microcontroller and a digital signal processor (DSP)), a programmable logic circuit (such as an application specific integrated circuit (ASIC), an array of field programmable gates (FPGAs), a programmable logic device (PLD) and programmable logic arrays (PLAs), a state machine, a logic gate, and discrete hardware components.

The computing unit 14 comprises a data processing unit 20 suitable for processing data, in particular by performing calculations, memories 22 suitable for storing data and a player 24 suitable for reading a computer-readable medium.

The user interface 16 comprises an input device 26 and an output device 28.

The input device 26 is a device which allows the user of the system 10 to enter information or commands into the system 10.

In FIG. 1, the input device 26 is a keyboard. In a variant, the input device 26 is a pointing device (such as a mouse, a touchpad and a graphics tablet), a voice recognition device, an eye sensor or a haptic device (movement analysis).

The output device 28 is a graphical user interface, i.e. a display unit designed for supplying information to the user of system 10.

In FIG. 1, the output device 28 is a display screen for a visual presentation of the output. In other embodiments, the output device is a printer, an augmented and/or virtual display unit, a loud-speaker, or other sound generating device for presenting the output in an audio form, a unit producing vibrations and/or odors or a unit suitable for producing an electrical signal.

In a specific embodiment, the input device 26 and the output device 28 are the same component forming human-machine interfaces, such as an interactive display.

The communication device 18 can be used for unidirectional or bidirectional communication between the components of the system 10. The communication device 18 is, for instance, a bus communication system or an input/output interface.

The presence of the communication device 18 makes it possible, in certain embodiments, that the components of the system 10 are distant from each other.

The computer program product 12 comprises a computer-readable medium 32.

The computer-readable medium 32 is a tangible device readable by the player 24 of the computing unit 14.

In particular, the computer-readable medium 32 is not a transient signal per se, such as radio waves or other freely propagating electromagnetic waves, such as light pulses or electronic signals.

Such a computer-readable storage medium 32 is, for instance, an electronic storage device, a magnetic storage device, an optical storage device, an electromagnetic storage device, a semiconductor storage device, or any combination thereof.

As a non-exhaustive list of more specific examples, the computer-readable storage medium 32 is a mechanically encoded device, such as punched cards or relief structures in a groove, a diskette, a hard disk, a read-only memory (ROM), a random-access memory (RAM), an erasable read-only memory (EROM), an electrically erasable and readable memory (EEPROM), a magneto-optical disk, a static random-access memory (SRAM), a compact disk (CD-ROM), a digital versatile disk (DVD), an USB key, a floppy disk, a flash memory, a solid state drive (SSD) or a PC card such as a PCMCIA memory card.

A computer program is stored on the computer-readable storage medium 32. The computer program includes one or a plurality of sequences of stored program instructions.

Such program instructions, when executed by the data processing unit 20, lead to the execution of steps of the evaluation method.

The form of program instructions is, for instance, a source code form, a computer-executable form, or any intermediate form between a source code and a computer-executable form, such as the form resulting from the conversion of the source code via an interpreter, an assembler, a compiler, a linker, or a locator. In a variant, the program instructions are a microcode, firmware instructions, state definition data, integrated circuit configuration data (for instance VHDL), or an object code.

Program instructions are written in any combination of one or a plurality of languages, for instance an object-oriented programming language (FORTRAN, C++, JAVA, HTML), a procedural programming language (C language for instance).

Alternatively, the program instructions are downloaded from an external source via a network, as is the case, in particular, for applications. In such case, the computer program product comprises a computer-readable data carrier on which the program instructions are stored or a data carrier signal on which the program instructions are encoded.

In each case, the computer program product 12 comprises instructions which can be loaded into the data processing unit 20 and [are] suitable for triggering the execution of the evaluation method when same are executed by the data processing unit 20. According to the embodiments, the execution is entirely or partially performed either on the system 10, i.e. a single computer, or in a system distributed between a plurality of computers (in particular via the use of cloud computing).

The operation of the system 10 will now be described with reference to FIG. 2 which is a flowchart of an example of implementation of the evaluation method.

The evaluation method is a method for evaluating the performance of a prediction algorithm for a plurality of distinct use cases.

The prediction algorithm is apt to predict, for given inputs, the value of one or a plurality of outputs.

The algorithm was trained using a machine learning technique and a learning data set.

More precisely, in the example which will be described, the algorithm is a supervised statistical learning algorithm.

Hereinafter, such an algorithm is denoted by a function ƒ: X→Y where the set X denotes the set of inputs of the algorithm and Y denotes the set of outputs of the algorithm.

The prediction algorithm is, for instance, a support vector machine, a neural network or a random forest. More generally, any type of supervised prediction algorithm is conceivable for the present context.

Such a prediction algorithm can be used for very diverse contexts such as image classification, three-dimensional shape recognition or decision-making support within the context of autonomous drone control.

Preferentially, the prediction algorithm inputs and/or outputs physical quantities corresponding to measurements from one or a plurality of sensors.

Hereinafter, as an illustration, it is assumed that the prediction algorithm is a digit recognition algorithm.

The recognition algorithm takes an image as input and determines the number contained in the image.

The method comprises the following steps: an obtaining step E50, a reception step E52, a collection step E54, a determination step E56, an aggregation step E58, an application step E60 and an establishing step E62.

In the obtaining step E50, n data sets are obtained.

The number n is an integer greater than or equal to 2, which is decomposed into a product n=nₚ×N, with nₚ an integer greater than or equal to 1, on the order of ten, and N an integer greater than or equal to 1, preferentially greater than or equal to 100. The numbers nₚ and N are defined more precisely hereinafter in the description.

Each data set includes a respective number n T of data.

The number n T of data in a set is at least greater than 2, preferentially greater than or equal to 100, and depends in practice on a time horizon T characteristic of the operational use of the prediction algorithm f considered.

Each datum of a data set corresponds to the output values that the prediction algorithm should give in the presence of the input values of the data set.

In the example described, it is assumed that a reference data set is known.

Such a set of references is a set comprising an image of each digit and including the associated digit.

The obtaining step E50 is then implemented by generation of each data set from the reference data set according to a given probability law.

Otherwise formulated, the generation is implemented by a random drawing according to a probability law.

As an example, the probability law is a uniform law.

According to a more elaborate example, for certain application cases, the number 1 is more frequent than the others. Also, the probability law could favor the generation of data sets with the number 1.

According to another example, the obtaining step E50 is implemented, for each data set, by generation, by a generative model of initial data and by selecting according to a given probability law, initial data for forming the data set.

A generative model is a machine learning algorithm which seeks to describe the data, making it possible, subsequently, to generate new samples according to the description (i.e. probability law) determined during the learning phase.

A classic example is a generative adversarial network used for the synthesis of very realistic (fictional) images from real images.

Another example is a Variational Autoencoder (VAE).

In other words, compared to the previous embodiment, instead of using reference data sets, data obtained using a generative model are used.

As a variant or in addition, the obtaining step E50 comprises the modification of the data sets (generated data sets or reference data sets) by introducing imperfections of the environment of the system the prediction algorithm models.

For instance, if the image for recognizing numbers is a scanned image from a handwritten note, the data sets can be modified taking into account the imperfections of the scanner used.

According to other examples, geometric transformations, taking into account noise or external disturbances are considered for the modification.

As external disturbances, it should be noted that the introducing of adverse disturbances aimed at manipulating the outputs of the prediction algorithm increases the robustness of the evaluation.

Thereby, in all cases, the obtaining step E50 is the result of the implementation of a generation of input/output pairs making it possible to obtain various realizations of random variables (x,y) under the measure of probability [symbol] _{x,y}.

At the end of the obtaining step E50, a finite set of input/output pairs is thereby obtained.

During the reception step E52, the probability for each data set that a data set is observed during a use case of the prediction algorithm is received.

As an example, if the data sets correspond to black and white images whereas, in the case of use, the images are in color, the case where the color images will be comparable to the case of black and white images has a certain probability.

Similarly, the distribution of numbers for use is not evenly distributed, so the probability of having certain numbers is higher than the probability of having other numbers.

During the collection step E54, the outputs predicted by the prediction algorithm for each input value of the data sets are collected.

Otherwise formulated, the prediction algorithm is applied to the input values and the result is collected by the system 10.

Thereby, for each input, the value predicted by the prediction algorithm and the value that the prediction algorithm should have predicted (true value), are known.

During the determination step E56, for each data set, the distribution of the prediction precision of the prediction algorithm is determined.

The precision of the prediction is obtained by applying an evaluation metric to a prediction error. Hereinafter, such an evaluation metric will be noted by cp.

A prediction error corresponds to the following quantity:

σ_{f}^{l}(x,y)=l(f(x),y)

Where:
x and y are realizations of the random variables x and y of joint distribution [symbol] _{x,y} and
l:Y×Y→ [symbol] ⁺ is a precision metric, also called loss function.

According to the example described, the prediction precision is calculated by a metric by means of the absolute prediction error.

However, any way of calculating the prediction precision is conceivable at such stage.

Thereby, according to one example, the prediction precision is calculated by using a cross entropy function.

In another example, the prediction precision is evaluated using a quantile metric.

More generally, the evaluation metric is constructed by applying a (p-metric to the empirical distribution of the random variable l(f(x),y).

Otherwise formulated, the evaluation metric is an empirical moment of the distribution of the prediction precision.

In a variant, the prediction precision is calculated by a metric using a reference prediction algorithm denoted by g.

According to a particular example, the evaluation metric is a function φ of the distribution of the relative precision between the algorithm f to be evaluated and the reference prediction algorithm g.

As an illustration, the metric is the mean of evaluation of the relative I-differences, which is written mathematically as follows:

ϵ_{f,g}^{rel}= [symbol] _{x,y}(l(f(x),g(x)))

It is also possible to refine the previous metrics by conditioning the metrics with respect to the precision of the reference prediction algorithm g.

The conditional mean of the relative I-differences is a particular example of such a metric, which is mathematically written as follows:

ϵ_{f,g}^{rel,cond}= [symbol] _{x,y}(l(f(x),g(x))|σ_{g}^{l}(x,y)∈[a_{g},b_{g}]⊂ [symbol] ⁺)

The evaluation metric is independently calculated on each data set.

It should be noted that the evaluation metric can be seen as a risk metric.

At the end of the determination step E56, nₚ distributions of the prediction error of the predicted output are thereby obtained. Each distribution is thereby a determined distribution specific to a respective data set sampled according to a distribution [symbol] _{x,y}ⁱ, with i an integer between 1 and nₚ, with

$${n}_{p} = \frac{n}{{n}_{T} \times N} ,$$

where N is the number of data sets used for obtaining a realization of the calculation of the prediction error.

Each of the determined distributions is denoted by

$${\hat{ϵ}}_{f , {n}_{T}}^{{ℙ}_{x , y}^{i}}$$

with i an integer between 1 and nₚ.

During the aggregation step E58, the determined distributions

$${\hat{ϵ}}_{f , {n}_{T}}^{{ℙ}_{x , y}^{i}}$$

are aggregated for obtaining an aggregated prediction error distribution or an aggregated prediction distribution denoted by

$${\hat{ϵ}}_{f , {n}_{T}}^{{ℙ}_{x , y}} .$$

For this purpose, an aggregation function is used, which uses the probabilities received.

For instance, the aggregation function is a weighted sum the weights μᵢ of which depend on the probabilities received.

The weights are sometimes referred to as priors μᵢ corresponding to each of the probability measures ( [symbol] _{x,y}ⁱ). Mathematically, the above amounts to constructing a distribution

$${\hat{ϵ}}_{f , {n}_{T}}^{{P}_{x , y}} , for {ℙ}_{x , y} = {\sum }_{i = 1}^{{n}_{p}} {μ}_{i} {ℙ}_{x , y}^{i} .$$

At the end of the aggregation step E58, an aggregated distribution of the prediction precision is obtained.

In the application step E60, a risk metric MR is applied to the error distribution of the aggregated prediction.

The value of the risk metric MR is used for obtaining an indicator of the performance of the prediction algorithm.

In a variant, a plurality of risk metrics MR are applied to the error distribution of the aggregated prediction, which is used for obtaining a plurality of performance indicators.

If need be, the method can include a subsequent step of aggregation of the performance indicators obtained.

According to a first example, the risk metric MR is the quantile of the error distribution of the aggregated prediction.

By denoting such a risk metric by MR1, it can be written mathematically as:

$$MR 1 ( k ) = {( {F}_{{\hat{ϵ}}_{f , {n}_{T}}^{{ℙ}_{x , y}}} )}^{- 1} ( k )$$

where F_{z}_{^{P}} denotes the repair function of the random variable z for the probability measure [symbol] and k is a variable.

The performance indicator is then the value of the risk metric MR1 for the level α, i.e. when k=α.

Otherwise formulated, the indicator of the performance of the prediction algorithm is the value of a quantile of predetermined level (herein the level α).

The level α is determined according to the criticality of the application envisaged for the prediction algorithm.

For instance, for character recognition use in companies, the level a on the order of could be acceptable, whereas for a prediction algorithm in the field of transport, an acceptable level of confidence a could be on the order of 10⁻⁷.

To understand well the relevance of an indicator based on the risk metric MR1, a parallel can be made with the risk metric VaR used in the finance world.

The abbreviation VaR stands for the Value-at-Risk.

The risk metric VaR is defined for a given time horizon T, a set S of scenarios and a confidence level α. The risk metric VaR thus corresponds to the amount of losses which should only be exceeded with a given probability over the time horizon T.

For the case of the risk metric MR1, the time horizon depends more particularly on the intended use case.

In addition, the time horizon takes into account the different constraints which could prevent a new training (re-calibration) of the algorithm. As a particular example, an algorithm onboard a satellite will have a greater risk horizon than a spam classifier.

Moreover, the set S of scenarios corresponds to a probability measure [symbol] _{x,y} specified jointly on the inputs and outputs considered. The probability measure depends more particularly on the operational application and the different risks to be measured.

It should be noted herein that the probability distribution represents a distribution associated with the use of the algorithm (i.e. [symbol] _{x,y}^{U}= [symbol] _{x,y}), which is decorrelated from the distribution of the inputs/outputs [symbol] _{x,y}^{E} used during the training of the prediction algorithm. To better understand the interest of such observation, it should be recalled that in learning theory, it is classic to look at the notion of average risk E_{f}, defined from the equation below:

ϵ_{f}= [symbol] _{x,y}(σ_{f}^{l}(x,y))

where [symbol] _{x,y} is the mathematical expectation operator defined with respect to the measure [symbol] _{x,y}.

In practice, however, the probability law [symbol] _{x,y} is unknown and the learning set is finite since same corresponds to n pairs {(xᵢ, yᵢ)}ᵢ₌₁ⁿ.

Thus, an estimator \hat{ϵ}_{f} of ϵ_{f}, called average empirical risk, is used. Mathematically, such an estimator is defined by:

$${\hat{ϵ}}_{f , n} = \frac{1}{n} {\sum }_{i = 1}^{n} {σ}_{f}^{l} ( {x}_{i} , {y}_{i} )$$

Distinguishing between the distribution used during the training [symbol] _{x,y}^{E}(training distribution) and the distribution associated with a use of the algorithm, denoted by [symbol] _{x,y}^{U} and named (use distribution), the present method also excludes the use of the notion of average risk by introducing an evaluation metric φ operating on the training [symbol] _{x,y}^{E} and use [symbol] _{x,y}^{U} distributions.

The above leads to feeding the training ϵ_{f}^{E} and use ϵ_{f}^{U} errors and the associated estimators thereof, namely the training error \hat{ϵ}_{f,n}^{E} and use error \hat{ϵ}_{f,n}^{U} estimators.

The training error ϵ_{f}^{E} is defined as follows:

ϵ_{f}^{E}=φ( [symbol] _{x,y}^{E},σ_{f}^{l})

Similarly, the use error ϵ_{f}^{U} is defined as follows:

ϵ_{f}^{U}=φ( [symbol] _{x,y}^{U},σ_{f}^{l})

The above leads to a training error \hat{ϵ}_{f,n}_{_{E}}^{E} estimator defined as follows:

$${\hat{ϵ}}_{f , {n}_{E}}^{E} = {\hat{φ}}_{{n}_{E}} ( {\{ ( {x}_{i}^{E} , {y}_{i}^{E} ) \}}_{i = 1}^{{n}_{E}} , {σ}_{f}^{l} )$$

Similarly, a use error \hat{ϵ}_{f,n}_{_{U}}^{U} estimator is defined as follows:

$${\hat{ϵ}}_{f , {n}_{U}}^{U} = {\hat{φ}}_{{n}_{U}} ( {\{ ( {x}_{i}^{U} , {y}_{i}^{U} ) \}}_{i = 1}^{{n}_{U}} , {σ}_{f}^{l} )$$

Such an approach also makes it possible to dispense with the so-called PAC (probably approximately correct) hypothesis which considers that the samples of the learning set correspond well to realizations of the law [symbol] _{x,y}. The above makes the evaluation of the algorithm much more relevant to the intended operational use, insofar as same might involve the processing of distributed data differently from the data forming the training set.

Returning to the analogy with the risk metric VaR, the confidence level α corresponds to the level α of the risk metric MR1.

With such formalism, the method can thereby be described in an alternative manner as follows.

For an algorithm, a given precision metric 1, the evaluation measure φ is calculated by constructing a distribution representative of the evaluation of the algorithm, over N realizations

$${\{ ( {x}_{i}^{j} , {y}_{i}^{j} ) \}}_{i = 1}^{{n}_{T}} ,$$

with j an integer between 1 and N, obtained from the distribution [symbol] _{x,y}, for the considered time horizon T. More particularly, the number n_{T} of samples to be considered per realization depends on the set time horizon and on the frequency of use of the algorithm.

Specifically, for each of the realizations

$${\{ ( {x}_{i}^{j} , {y}_{i}^{j} ) \}}_{i = 1 ′}^{{n}_{T}} ,$$

the prediction error is calculated according to the following formula:

$${\hat{ϵ}}_{f , {n}_{T}}^{{ℙ}_{x , y} j} = {\partial }^{𝔧} {\hat{φ}}_{{n}_{T}} ( {\{ ( {x}_{i}^{j} , {y}_{i}^{j} ) \}}_{i = 1}^{{n}_{T}} , {σ}_{f}^{l} )$$

An empirical distribution of the random variable is

$${\hat{ϵ}}_{f , {n}_{T}}^{{ℙ}_{x , y}}$$

thereby constructed and the value of the risk metric MR1, i.e. the performance indicator, is obtained as the quantile of level a of the distribution. Mathematically, the above means that the probability P that the prediction error exceeds the value of the performance indicator is equal to 1−α, which is written:

$$P ( {\hat{ϵ}}_{f , {n}_{T}}^{{ℙ}_{x , y}} \geq MR 1 ( α ) ) = 1 - α$$

The analogy between the risk metric MR1 and the risk metric VaR shows that the performance indicator is as efficient as the risk metric VaR. However, the performance of the latter is recognized since the VaR risk metric is used at the regulatory level in the financial field, which proves the relevance and the robustness thereof. Indeed, regulations in said field have become much more stringent since the subprime crisis of 2008.

According to another example, the risk metric is a conditional expectation and an indicator of the performance of the prediction algorithm is a value of the conditional expectation.

Using the previous notations, one gets:

$$MR 2 = {𝔼}_{x , y} [ {\hat{ϵ}}_{f , {n}_{T}}^{{ℙ}_{x , y}} \geq EC 2 ]$$

In the previous expression, MR2 refers to the risk metric obtained as the value of a conditional expectation and EC2 the limit value used for conditioning.

The above is used for obtaining another indicator of the performance of the prediction algorithm.

By a reasoning similar to the reasoning developed for the first risk metric, such a performance indicator is as good as a metric known by the acronym C-VaR referring to Conditional Value-at-Risk. Such metric is also known as expected-shortfall.

Furthermore, the method described with reference to FIG. 2 comprises a step E62 of establishing a report giving all the information used for obtaining the performance indicator.

For instance, such a report is generated in pdf format. Advantageously, the report is generated from latex code generated on the fly.

The content of the report is, according to the example proposed, a set of three types of information.

The first type of information groups together the information provided at the beginning of the method by highlighting more particularly the number of algorithms to be evaluated, the number of scenarios (data sets) considered and the different risk metrics to be considered.

The second type of information relates to the risks for each algorithm for a data set and a risk metric. For instance, a histogram of the risk metric values is presented as a histogram or a graph.

The third type of information relates to the aggregated risks for each algorithm for a risk metric. For instance, the algorithm, the risk metric, the different priors used and, if appropriate, an aggregation of the different values found for the different performance indicators, will be indicated.

Such a report can be directly used by a user.

The present method is thereby a method equipped for the measurement and management of risks associated with the use of supervised statistical learning algorithms within a specific framework.

The method gives a realistic measure of the performance of the algorithm on all the data which can be submitted to the algorithm, unlike a certification method which would only validate the performance of the algorithm under such specific conditions of use.

The method leads to a good precision for all cases which can occur in practice.

The present method has the advantage of being generic in the sense that the method can be applied to any type of prediction algorithm in a supervised learning context, any type of input and any envisaged use case.

Furthermore, the present method can be used at all stages of the life of the algorithm, and in particular in the development phase, the validation phase and the follow-up phase (after deployment of the algorithm).

During the development phase, the method can be used for obtaining the performance and thus facilitates the comparison of two candidate versions of the algorithm. The development is thus accelerated. The method can also be used for calibrating hyper-parameter values or for associating confidence indicators with the outputs of the selected algorithms.

The validation phase aims to ensure that the algorithms developed are in line with the intended operational use, focusing more particularly on the impacts related to the different sources of potential errors associated with the use thereof. In particular, the input/output range for which the algorithm behaves according to the intended operational application is specified during said phase.

The follow-up phase consists of periodically evaluating the prediction algorithm to ensure that the validation performed remains valid for the observed conditions of use.

The method was implemented by the applicant according to several modules, namely a module for obtaining data sets, a module for collecting predicted values, a determination module, an aggregation module and an application module. Each of the modules has been successfully implemented in the Python programming language. However, any type of object-oriented language, in particular one with polymorphism, would also lead to obtaining a good operating efficiency.

Such a modular implementation makes the method easily adaptable to all types of algorithm since each module is relatively independent.

Moreover, the method can be easily parallelized, which limits the computational load, in particular by using a distributed computing structure.

It should be noted that parallelization is thought of at the level of the different parameters used for the definition of scenarios, and at the level of the calculation of the different associated distributions, where each of the realizations of a given scenario can be treated individually.

Other embodiments are possible.

According to one embodiment, the method further includes a display of all of said information on the output device 28 which then serves as a graphical interface with a user.

Such a display would be a replacement or an addition to the report established by allowing the user to see the different results and performance indicators and to conduct detailed analyses by making possible a navigation through the different results files and a modularity in the choice of risk metrics.

More particularly, the user will be able to, if he/she wishes, convert a given algorithmic risk tolerance level into valid ranges for the algorithms considered via the analysis of the contributions of the different scenarios.

In a variant or in addition, the graphical interface can be used for forming a configuration file giving all the information useful for implementing the method, in particular the information of the obtaining steps E50 and the receiving step E52.

For this purpose, the output device 28 allows the user to enter the associated data or to select same via the use of drop-down menus.

As a particular example, the configuration file includes the parameters needed for defining the risk metrics to be calculated, the algorithms to be evaluated, the precision metrics to be considered, the different data sets to be considered, the methods for simulating sets of data sets, reference algorithms and priors.

Finally, it will be clearly understood that the order of the steps in the evaluation method which has just been described can be different and, in particular, that certain steps can be carried out simultaneously.

More generally, any technically possible combination of the preceding embodiments making it possible to obtain a method for evaluating the performance of a prediction algorithm for a predefined use case, is envisaged.

Such an evaluation method is thereby a method of measuring the performance of an algorithm.

As a particular example, the evaluation method measures the precision of the predictions of the algorithm. If the algorithm is a temperature prediction method, the evaluation method measures the temperature difference between the actual temperature and the predicted temperature.

The performance evaluated is thus an objective data since same is a measure. The way in which performance is evaluated, i.e. the index or indices chosen to evaluate same, is herein indifferent.

To repeat the previous example, whether the temperature deviation is expressed in absolute terms or as a quaestablishic deviation or otherwise, does not change the fact that the performance thereby evaluated is a representative measure of the temperature deviation between the actual temperature and the predicted temperature.

Furthermore, by making it possible to obtain a more accurate measurement, the evaluation method thereby becomes a technical method solving a problem of precision of a measurement. The evaluation method is thus a technical solution to a technical problem.

1. A method for evaluating the performance of a prediction algorithm for a predefined use case, the prediction algorithm predicting for given inputs the value of one or a plurality of outputs, the prediction algorithm having been trained using a machine learning technique and a learning dataset, the method including the steps of:
obtaining data sets, each datum of a data set corresponding to the output values that the prediction algorithm should give in the presence of the input values of the data set,
reception of the probability, for each data set, that a data set is observed during use case of the prediction algorithm,
collecting the outputs predicted by the prediction algorithm for each data input value of the data sets,
determining the distribution of the prediction precision of the predicted output for each data set, for obtaining determined distributions,
aggregating distributions determined by using an aggregation function using the probabilities received, for obtaining an aggregated distribution of prediction precision, and
applying at least one risk metric to the aggregated distribution of prediction precision, for obtaining at least one indicator of the performance of the prediction algorithm.

2. The evaluation method according to claim 1, wherein a risk metric is a quantile metric and an indicator of the performance of the prediction algorithm is the value of a quantile of predetermined level.

3. The evaluation method according to claim 1 or 2, wherein a risk metric is a conditional expectation and an indicator of the performance of the prediction algorithm is a value of the conditional expectation.

4. The evaluation method according to any one of claims 1 to 3, wherein the prediction precision is calculated using an evaluation metric, the evaluation metric being an average of the absolute prediction error, a quantile metric, or an empirical moment of the distribution of the prediction precision.

5. The method according to any one of claims 1 to 4, wherein the prediction precision is calculated using a reference prediction algorithm.

6. The evaluation method according to any one of claims 1 to 5, wherein the method includes establishing a report giving all the information from which the performance indicator was obtained.

7. The evaluation method according to any one of claims 1 to 6, wherein the obtaining step is carried out by generating each data set from a reference data set according to a given probability law.

8. The evaluation method according to any one of claims 1 to 6, wherein the obtaining step is carried out, for each data set, by generating, by means of a generative model of initial data and by selecting the initial data for forming the data set, according to a given probability law.

9. The evaluation method according to claim 7 or 8, wherein the obtaining step includes the modification of the data sets by introducing imperfections in the environment of the system the prediction algorithm models.

10. The evaluation method according to any one of claims 7 to 9, wherein the obtaining step includes the modification of the data sets by introducing adverse perturbations aimed at manipulating the outputs of the prediction algorithm.

11. A computer program product including a readable storage medium on which is stored a computer program comprising program instructions, wherein the computer program can be loaded on a data processing unit and leads to implementing an evaluation method according to any one of claims 1 to 10 when the computer program is implemented on the data processing unit.

12. A readable storage medium including program instructions forming a computer program, the computer program being loadable on a data processing unit and implementing an evaluation method according to any one of claims 1 to 10 when the computer program is implemented on the data processing unit.

1. A method for evaluating the performance of a prediction algorithm for a predefined use case, the prediction algorithm predicting for given inputs the value of one or a plurality of outputs, the prediction algorithm having been trained using a machine learning technique and a learning dataset, the method including the steps of:
obtaining data sets, each datum of a data set corresponding to the output values that the prediction algorithm should give in the presence of the input values of the data set, reception of the probability, for each data set, that a data set is observed during use case of the prediction algorithm,
collecting the outputs predicted by the prediction algorithm for each data input value of the data sets,
determining the distribution of the prediction precision of the predicted output for each data set, for obtaining determined distributions,
aggregating distributions determined by using an aggregation function using the probabilities received, for obtaining an aggregated distribution of prediction precision, and applying at least one risk metric to the aggregated distribution of prediction precision, for obtaining at least one indicator of the performance of the prediction algorithm.

2. The evaluation method according to claim 1, wherein a risk metric is a quantile metric and an indicator of the performance of the prediction algorithm is the value of a quantile of predetermined level.

3. The evaluation method according to claim 1, wherein a risk metric is a conditional expectation and an indicator of the performance of the prediction algorithm is a value of the conditional expectation.

4. The evaluation method according to claim 1, wherein the prediction precision is calculated using an evaluation metric, the evaluation metric being an average of the absolute prediction error, a quantile metric, or an empirical moment of the distribution of the prediction precision.

5. The method according to claim 1, to wherein the prediction precision is calculated using a reference prediction algorithm.

6. The evaluation method according to any one of claims 1 to 5, wherein the method includes establishing a report giving all the information from which the performance indicator was obtained.

7. The evaluation method according to claim 1, wherein the obtaining step is carried out by generating each data set from a reference data set according to a given probability law.

8. The evaluation method according to claim 1, wherein the obtaining step is carried out, for each data set, by generating, by means of a generative model of initial data and by selecting the initial data for forming the data set, according to a given probability law.

9. The evaluation method according to claim 7, wherein the obtaining step includes the modification of the data sets by introducing imperfections in the environment of the system the prediction algorithm models.

10. The evaluation method according to claim 7, wherein the obtaining step includes the modification of the data sets by introducing adverse perturbations aimed at manipulating the outputs of the prediction algorithm.

11. A computer program product including a readable storage medium on which is stored a computer program comprising program instructions, wherein the computer program can be loaded on a data processing unit and leads to implementing an evaluation method according to claim 1 when the computer program is implemented on the data processing unit.

12. A readable storage medium including program instructions forming a computer program, the computer program being loadable on a data processing unit and implementing an evaluation method according to claim 1 when the computer program is implemented on the data processing unit.
